(19) United States
(12) Patent Application Publication
(10) Pub. No.: US 2013/0033372 A1
(43) Pub. Date: Feb. 7, 2013

(54) SYSTEMS AND METHODS OF VEHICLE CONDITION ALERT

(71) Applicants: Raul Vicente Medel, Sunrise, FL (US); Marta Hortensia Medel, Sunrise, FL (US)

(72) Inventors: Raul Vicente Medel, Sunrise, FL (US); Marta Hortensia Medel, Sunrise, FL (US)

(21) Appl. No.: 13/567,018

(22) Filed: Aug. 4, 2012

Related U.S. Application Data
(60) Provisional application No. 61/574,513, filed on Aug. 4, 2011.

(51) Int. Cl. G08B 21/02

(52) U.S. Cl. 340/438

(57) ABSTRACT

The present invention provides a system for monitoring the usage of individual vehicular seat belts. The seat belt provides a visual indication of seat belt usage using a plurality of light emitting diodes (LEDs) to alert the compliance of proper seat belt usage. The system is capable of providing a visual indication, an audible indication, a historical timestamp for seat belt usage, a display and/or data relating to seat belt use to a communication interface. The processing module is capable of storing and outputting prior and current use of seat belt usage to any third party entities monitoring such use.

### CROSS REFERENCE TO RELATED APPLICATIONS

This application claims the benefit of the filing dates of: 1) U.S. Provisional Patent Application No. 61/574,513, filed on Aug. 4, 2011, the disclosure of which is incorporated herein by reference.

### BACKGROUND

Embodiments of the present invention generally relate to the field of seatbelt and safety belts and specifically, the present invention relates to a seatbelt apparatus with automatic indication of the status of a seatbelt. The seat belt apparatus provides the means for producing a visual indication of the status of latching mechanism, particularly whether the user has engaged a safety belt with both ends of the latching mechanism, This visual indication can provide a notification to other passengers, safety monitoring personnel and external peace keepers, such as police officers and paramedics.

Seat belts, such as those used in motor vehicles and most mobile equipment requiring the restraining of a user or passenger, are well known in the art. Studies by the federal government, automotive manufacturers, aerospace institutes and insurance agencies have shown that the use of a seat belt or safety restraint significantly reduces the risk of injury to the passenger of such vehicles in the unfortunate event of a collision or accident.

Law makers have also recognized the life-saving benefits of seat belts usage. Municipalities and insurance regulations have enacted laws which require passengers to wear their seat belt or safety harness by all occupants of a motor vehicle, aircrafts, and other dangerous motorized equipment, including construction equipment and amusement park rides.

Local police departments other public safety personnel have taken the task of enforcing these rules requiring seat belt restraints. Currently, seat belt use has to be determined by a police officer or other public safety person observing a moving vehicle and visually confirming that the seat belt is engaged by the passengers. This observation process can be tedious and time consuming, thus taking personnel away from more pressing issues that would require their attention. Additionally, the effectiveness of long distance determinations decrease as the distance increases. Passengers may also attempt to deceive the public safety officer by pulling the strap over their shoulder without latching the seat belt during the initiation of a traffic stop.

Additionally, racial profiling is a real concern for citizens of various ethnic backgrounds. Seat belt use is a common pretext for initiating an illegal stop.

It is therefore desirable to aide officials and the public in the observation of subject individuals by providing a supplementary indication of seat belt usage by the occupants of a vehicle.

These problems have previously been attempted to be corrected. Such a system is the system of U.S. Pat. No. 4,849,733 issued to Conigliaro et al, where a means for providing rearward-facing lights on the exterior of a vehicle which illuminate to indicate that the passenger has not fastened their seat belt.

U.S. Pat. App. No. 2005/0156726 to Rubel teaches a seat belt usage monitoring system for recording seat belt usage information locally within the vehicle, and for transmitting the information to a remote monitoring receiver.

What is missing from the prior related art is a system which incorporates a seat belt monitoring system that does not require expensive custom installations, manufacturer recalls or engineering changes. Another disadvantage of the prior art is there isn't a simple and easy way for users to be able to determine which state the seat belt is in, readily and automatically, based on each situation. Another disadvantage is motivating all interest parties to incorporate new equipment and receivers for determining the status seat belt restraints. Additionally, another disadvantage of the prior art systems is the existing systems are not well-suited for use in non-motor vehicle applications.

### SUMMARY

In accordance with one embodiment, a seat belt provides usage indicator that is readily incorporable into the design of new production vehicles at minimal cost or effort.

It is another object of the present invention to provide a seat belt usage indicator which is easily customizable into pre-existing vehicles

It is another object of the present invention to provide the status of seat belt via a seat belt indicator which is coupled to the latch of a seat belt to allow for a quick and accurate means of determining the status of a seat belt harness.

More specifically, the seat belt indicator includes light-emitting diodes (hereinafter “LEDs”) to visually alert that a seat belt latch is not engaged with an array of red lights. The seat belt indicator includes LEDs to visually alert that a seat belt latch is engaged with an array of green lights. These LED arrays are Illuminated RED when the ignition is turned on when the driver buckles the seat belt and the ignition is on, the LEDs switch to green.

It is another object of the present invention to provide the door closure monitors, which are coupled to the door jamb to allow for indication of whether the door is open or closed. Along with the door status, the status of whether the ignition was in the on or off position is determined. This will provide relevant data surrounding the circumstances of the vehicle during the historical recording of the seat belt use status. Accelerometers are included to measure and determine whether the vehicle as in motion or at rest.

It is another object of the present invention to communicate with global positioning satellite systems to provide real-time location data in order to confirm use of seat belt restraints at a specific location. This may come in handy at a court appearance for a traffic citation to refute allegations of non-compliance. In addition to providing location information for future distinct uses, it may also be helpful to provide a microphone to record the audio of the incident where the police or personnel observed the infraction.

Yet another aspect of the present invention is to provide electronic circuitry that provides data, which is in communication with a database, to store a timestamp and a status of a seat belt associated with a particular point in time. The database is accessible to a user for creating a report of the seat belt monitoring system. Reports can be transmitted via email, SMS or Bluetooth file transfer. They can also be viewed by a graphical user interface display or transmitted to a printer.

It is another object of the present invention to provide a spoken audible alert as to the status of a seat belt at the request of an occupant to read aloud the contents of the database, which includes a timestamp and a status of the seat belt restraint. The audio files recorded by the attached microphone can be stored and retrieved from the database which, stores all of the historical data related to determining the use of the seat belt restraints.

### DRAWINGS

The drawings, in which like numerals represent similar parts, illustrate generally, by way of example, but not by way of limitation, various embodiments discussed in the present document.

FIG. 1 illustrates a block diagram of the components of the seat belt monitoring system of the present invention in accordance with an embodiment.

FIG. 2 is a schematic view of the user of the seat belt restraint monitoring system in the chair with LED lights illuminating from the seat belt in accordance with an embodiment.

FIG. 3 is a schematic view of the seat belt monitoring system from the exterior of a vehicle in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

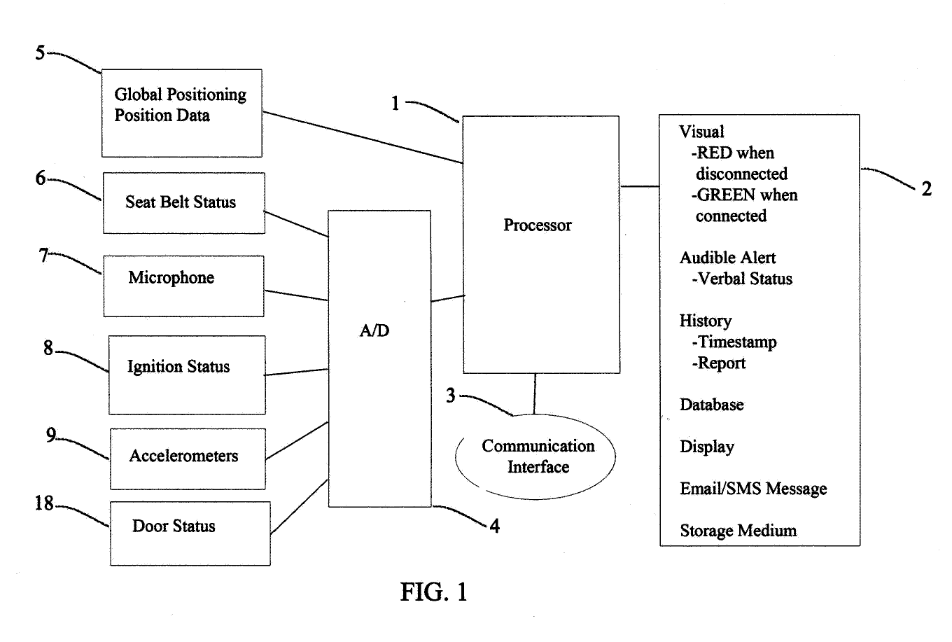

FIG. 1 is a block diagram of the system for providing an indication of the status of the seat belt monitoring system according to one embodiment of the present invention. As shown in FIG. 1, a seat belt monitoring system provides a seat belt status sensor 6, which determines when the latch in the seat belt is engaged. The latch for the seat belt status sensor 6 has a switch or proximity sensor that receives an analog signal of the output. The analog signal is converted to digital data b analog-to-digital converter 4 and sent to processing module 1 for further processing. The seat belt monitoring system also includes an ignition status sensor 8 that receives an analog signal from the ignition switch when the vehicle's ignition is triggered. The ignition status sensor 8 sends the analog signal to analog-to-digital converter 4. The output of analog-to-digital converter 4 is sent to processing module 1 for further processing. The seat belt monitoring system includes accelerometers 9 to measure the forces experienced by the vehicle 20. These forces measured by accelerometers 9 represent forces present when vehicle 20 is in motion and the seat belt restraints are required to be in use. Door status sensors 18 are used to determine whether the door is open or closed. The door status sensor 18 sends an analog signal to analog-to-digital converter 4, which is then sent to processing module 1 for further processing. Global Positioning Satellite. (GPS) receiver 5 provides location information. Positional data is helpful in determining where the seat belt was in use in the unlikely event the use needs to be proven at a specific time and location. In addition to providing location information data, an audio file is created from the input of microphone 7. Audio data may also be helpful in providing irrefutable evidence of whether a seat belt violation occurred or was some pretext for some non-existent probable cause to initiate a stop.

Processing module 1 receives all of the various inputs from the above-mentioned sensors and transmitters and creates a historical database for future use by the end user, as shown by output 2. The report can be used to provide proof of seat belt use to an interested third party. The interested third party can be an employer, an insurance provider, a magistrate court or safety inspection personnel. Additionally, the seat belt monitoring system can provide real-time output in the form of an audible confirmation of when and where a seat belt was in fact in use.

Specifically, the visual indication of the seat belt use occurs externally with LEDs. The LEDs attached to the seat belt monitoring system will illuminate either red or green depending on the status of the seat belt connection. The seat belt LEDs will illuminate green when the seat belt is illuminated, the door is closed and the ignition has been initiated. When one of the conditions is not met, whether it that a door is open, the car is off or the seat belt is not engaged, the LEDs will illuminate red.

Other outputs are possible from processing module 1. An audible alert can be output to remind the user to use the seat belt. This audible alert can be played back on the speaker of the vehicle. The audible alert can read back the location and status of the seat belt at a particular time. The historical data can be transmitted to a database or sent to a storage medium for further processing. The data from processing module 1 can also be displayed on a PDA or cellular telephone for further use. The data can be sent via Bluetooth, email or SMS messaging to allow for further processing and presentation on other devices.

The historical data report can be sent via a communication interface 3 to other devices or networks to further increase the reportability of the seat belt use status,

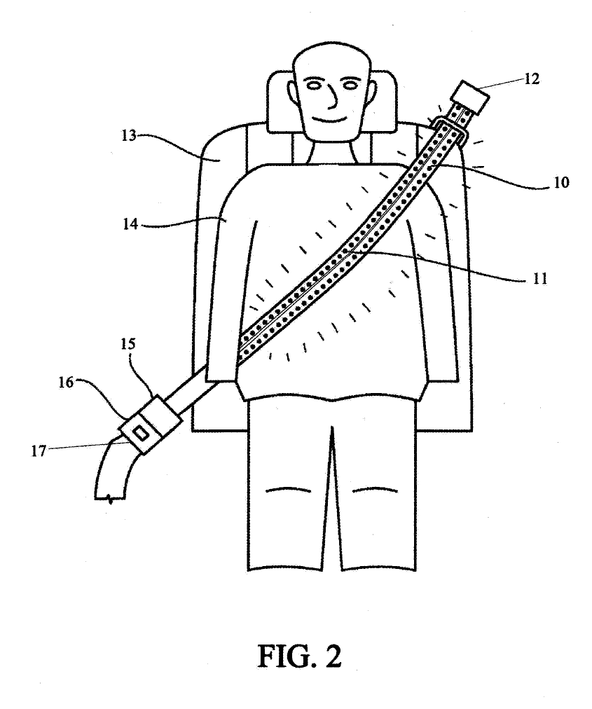

FIG. 2 is a schematic view of user 14 positioned in a chair 13. When seat belt latch 15 is connected to seat belt buckle 16, seat belt switch 17 sends a positive status signal to processing module 1, and the ignition status sensor 8 sends a positive signal to processing module signal 1 the seat belt monitoring begins to record a status of connected into a database. Red LEDs 10 are constantly illuminating red while ignition status sensor 8 is receiving a signal. Green LEDs 11 are illuminated when the condition mentioned above are met. The LEDs provide a visible indication as to the status of the seat belt use of the user, The LEDs are visible from a moderate distance away from vehicle 20, allowing police officers and other safety personnel clear indication as the user's compliance with any seat belt use requirements.

Seat belt monitoring system circuitry is enclosed within a housing 12. Processing module 1 and other components of the system are included on an integrated circuit and housed within housing 12. Housing 12 is attached to the seat belt monitoring system in vehicle 20. The various embodiments and/or components, for example, the modules, elements, or components and controllers therein, also may be implemented as part of one or more computers or processing modules. The computer or processing module may include a computing device, an input device, a display unit and an interface, for example, for accessing the Internet. The computer or processing module may include a micro processing module. The micro processing module may be connected to a communication bus. The computer or processing module may also include a memory. The memory may include Random Access Memory (RAM) and Read Only Memory (ROM). The computer or processing module further may include a storage device, which may be a hard disk drive or a removable storage drive such as an optical disk drive, solid state disk drive (e.g., flash RAM), and the like. The storage device may also be other similar means for loading computer programs or other instructions into the computer or processing module.

As used herein, the term “computer” or “module” may include any processing module-based or micro processing module-based system including systems using microcontrollers, reduced instruction set computers (RISC), application specific integrated circuits (ASICs), field-programmable gate arrays (FPGAs), graphical processing units (GPUs), logic circuits, and any other circuit or processing module capable of executing the functions described herein. The above examples are exemplary only, and are thus not intended to limit in any way the definition and/or meaning of the term “computer”.

The computer or processing module executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processing module as a processing machine to perform specific; operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

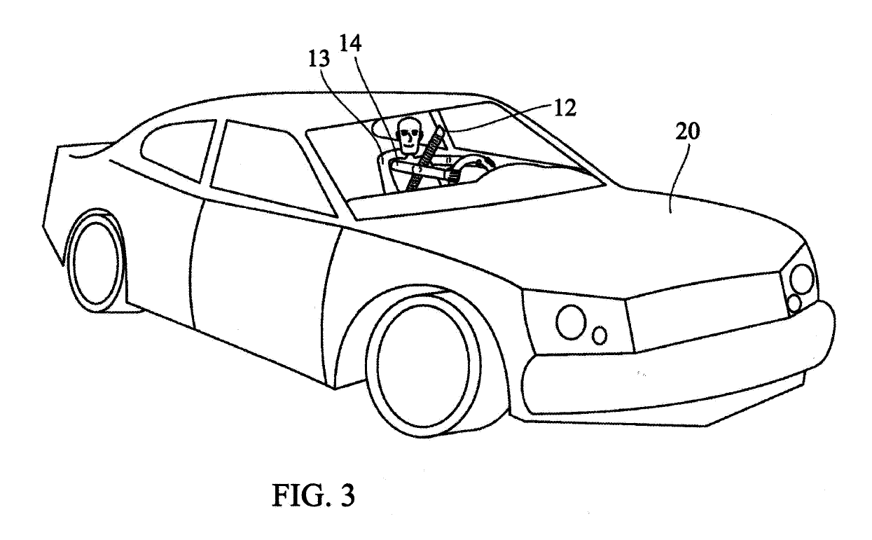

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. FIG. 3 is a schematic view of the seat belt monitoring system within vehicle 20. The seat belt monitoring system is highly visible from the exterior of the vehicle.

In an alternate embodiment of the subject matter disclosed herein, the system for monitoring status of a vehicle may be used to provide indication of the current and/or prior usage of the vehicle. The system may include a plurality of sensors for capturing a plurality of conditions of the vehicle. The vehicle as used herein may be any vehicle with or without motor.

The system may include a communication module for communicating the signals over a network. The communication module may communicate signals over a wired or a wireless network. For example, the communication module may transfer data over a wired network such as local area network (LAN), HI-FI cable, USB, and the like. Optionally, the communication module may transfer data over a wireless network such as a Bluetooth, SMS messaging, Wi-Fi and the like. The plurality of sensors may be capable of capturing electrical signals, sound signals, light signals, mechanical signals, and the like.

The system may further comprise a processing module for processing the outputs of the plurality of sensors. In one embodiment, the processing module may be located within the vehicle body, so that the data or signal from the sensors may be processed and stored within the vehicle. Optionally, the processing module for processing the signals may be located at a remote location. A processing module may be a single computer or a cluster of computer system connected together in a series or a parallel connection.

In one embodiment of the subject matter described herein, the system may also include a storage module for storing the plurality of signal received from the sensors. As used herein, the term signal or data may be used interchangeably. The signal/data that may be received from the plurality of sensors may be stored in the storage module appended with a data and/or a time stamp at the time of storage. Additionally, the system may have a backup module for remotely backing up the data from the storage module.

As used herein, the term appended is to be broadly construed. For example, appended may be construed as appending the date and/or the time stamp to the file name. Optionally, appended may mean adding the date and/or the time stamp to the header of a file to store the data/signal. Yet another option may be to store the data/signal in a structured format, linking data with the date and/or the time. Furthermore, the storage module may be a structured storage module or an unstructured storage module or any combination thereof.

In one another aspect of the subject matter disclosed herein, the system may have a plurality of alerting means. Each of the plurality of alerting means may be further configured to produce alert for a plurality of conditions. The plurality of alerting means may be any of a visual, an audible or a mechanical means, or any combination thereof. For example, the alerting may be any of a visual alert, an audible alert, a printable report, an email, SMS message. Optionally, at least one alerting means may be a plurality of light emitting diodes (LEDs). The plurality of LEDs may be configured such that each of the plurality of LEDs may emit different color light, such that each color represents a different condition.

Optionally, the system may allow the alerts or sensors to be manually configured. For example, the alerts or sensors are capable of manual configuration by a user or a manufacturer or a dealer or any combination thereof. The configuration of sensors may be available for each of the sensors, or as a group for a combination of sensors.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by hose of ordinary skill in the art. Rather it is hereby intended the scope be defined by the claims appended hereto.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. In a seat belt restraint, a seat belt monitoring system for indicating the current and/or prior compliance of proper usage of said seat belt restraint in a vehicle, the system comprising:
a seat belt restraint system including a seat belt restraint having a restraining belt, a latch, a buckle, a plurality of sensors for monitoring proper seat belt use, and a processing module for processing the outputs of the said plurality of sensors;
a first plurality of light emitting diodes (LEDs) coupled to the restraining belt, wherein the first plurality of LEDs emit a red light, when a fault condition exists;
a second plurality of light emitting diodes (LEDs) coupled to the restraining belt, wherein the second plurality of LEDs emit a green light when no fault conditions exist;
wherein the fault conditions are selected from a group consisting of any of a seat belt status fault, an ignition status fault and an door status fault; and
alerting means for alerting the status of the seat belt usage to a user, wherein the alerting of the status is selected from a group consisting of any of a visual alert, an audible alert, a printable report, a database, a storage medium, an email, SMS message, and a network transmission.

2. The seat belt monitoring system according to claim 1, wherein the seat belt system includes a seat belt status sensor for determining whether the latch is connected to the buckle.

3. The seat belt monitoring system according to claim 1, wherein the seat belt system includes an ignition sensor for determining whether the ignition in the vehicle system has been triggered.

4. The seat belt monitoring system according to claim 1, wherein the seat belt system includes at least one door status sensor for determining whether a door of the vehicle is ajar.

5. The seat belt monitoring system according to claim 1, wherein the second plurality of LEDs will continue to be illuminated red until each of the seat belt status sensor, the ignition status sensor and the door status sensor detect the seat belt latch and buckle is connected, the ignition is on, and the door is closed, respectively.

6. The seat belt monitoring system according to claim 1, wherein the alerting means for alerting the status of the seat belt usage includes an audible alert capable of reading aloud the usage of a seat belt restraint system at a particular time.

7. The seat belt monitoring system according to claim 6, wherein the system includes a global positioning receiver that receives a location correlated to when and where a seat belt restraint was in use.

8. A system for monitoring status of a vehicle for indicating the condition of a current and/or a prior usage of the vehicle, the system comprises:
a plurality of sensors for a vehicle for capturing a plurality of conditions of the vehicle;
a communication module for communicating the signals over a network;
a processing module for processing the outputs of the said plurality of sensors;
a storage module for storing the plurality of signal received from the sensors, wherein the plurality of signal are appended with at least one of a date or a time stamp at the time of storage; and
a plurality of alerting means, wherein each of the plurality of alerting means configured to produce alert for a plurality of conditions.

9. The system of claim 8, wherein the sensor is capable of capturing electrical signals, sound signals, light signals, mechanical signals, and the like.

10. The system of claim 8, wherein the communication module communicates a plurality of signals over a wired or a wireless network.

11. The system of claim 8, wherein the processing module for processing the signals is located within the vehicle.

12. The system of claim 8, wherein the processing module for processing the signals is located at a remote location.

13. The system of claim 8, wherein the processing module is a single computer or a multiple computer processing system.

14. The system of claim 8 further comprising a backup module for remotely backing up the data from the storage module.

15. The system of claim 8, wherein the plurality of alerting means is at least one of a visual, an audible or a mechanical means, or any combination thereof.

16. The system of claim 15, wherein at least one alerting means is a plurality of light emitting diodes (LEDs), wherein each of the plurality of LEDs is configured to emit different color light, such that each color represents a different condition.

17. The system of claim 8, wherein the system is capable of manual configuration by a user or a manufacturer or a dealer or any combination thereof.

18. The system of claim 17, wherein the configuration is available for at least one of the sensors, or a combination of sensors.

19. The system of claim 8, wherein alerting comprises of any of a visual alert, an audible alert, a printable report, an email, SMS message, and a network transmission.

20. The system of claim 8, wherein the storage module is at least one of a structured storage or an unstructured storage or any combination thereof.
